(19) United States
(12) Patent Application Publication
(10) Pub. No.: US 2012/0173748 A1
(43) Pub. Date: Jul. 5, 2012

(54) HYBRID TRANSPORT-LAYER PROTOCOL MEDIA STREAMING

(75) Inventor: Imed Bouazizi, Tampere (FI)

(73) Assignee: Nokia Corporation

(21) Appl. No.: 12/983,626

(22) Filed: Jan. 3, 2011

(51) Int. Cl. G06F 15/16

(52) U.S. Cl. 709/231

(57) ABSTRACT

An example method includes a client causing establishment of a streaming session of the client with a server to receive a stream of media data from the server, including receiving a description of the session. The description indicates delivery of a first portion of the media data to the client over a first transport-layer protocol, and indicates delivery of a second portion of the media data to the client over a second transport-layer protocol. The example method also includes the client causing receipt of the first and second portions of the media data transmitted to the client over respective ones of the first and second transport-layer protocols, where the first and second portions are received in an at least partially overlapping or even synchronous manner. The method may further employ a congestion control algorithm relative to the portions delivered over the first and second transport-layer protocols.

### TECHNICAL FIELD

An example embodiment of the present invention generally relates to media streaming and, more particularly, relates to media streaming over a combination of different transport-layer protocols.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer. Current and future networking technologies, as well as evolved computing devices making use of networking technologies, continue to facilitate ease of information transfer and convenience to users. In this regard, the expansion of networks and evolution of networked computing devices has provided sufficient processing power, storage space, and network bandwidth to enable the transfer and playback of increasingly complex media files. Accordingly, media streaming functionality such as Internet television, video and audio sharing, and the like are gaining widespread popularity.

Although many techniques have been developed for media streaming, it is generally desirable to improve upon existing techniques.

### BRIEF SUMMARY

Example embodiments of the present invention provide an improved apparatus, method and computer-readable memory for hybrid transport-layer protocol media streaming. According to a first aspect of example embodiments of the present invention, a method may include a client causing establishment of a streaming session of the client with a server to receive a stream of media data from the server, including receiving a description of the session. The description indicates delivery of a first portion of the media data to the client over a first transport-layer protocol such as the Transmission Control Protocol (TCP), and delivery of a second, different portion of the media data to the client over a second, different transport-layer protocol such as User Datagram Protocol (UDP), the server partitioning the media data into the first and second portions. The method may also include the client causing receipt of the first portion of the media data transmitted to the client over the first transport-layer protocol, and receipt of the second portion of the media data transmitted to the client over the second transport-layer protocol. In this regard, the client receives the first and second portions of the media data in an at least partially overlapping or even synchronous manner.

The method of this aspect may further include the client determining an indication of a measured throughput of the first portion of the media data transmitted to the client over the first transport-layer protocol, and/or an indication of a buffer state related to the first portion of the media data received by the client over the first transport-layer protocol. And the method may further include the client preparing the indication for transmission to the server. This indication enables the server to control an amount or rate of the second portion of the media data transmitted to the client over the second transport-layer protocol based on the measured throughput or buffer state.

According to a second aspect of example embodiments of the present invention, a method may include a server partitioning a media data into a first portion and a second, different portion for delivery to a client during a streaming session. The media data is partitioned into the first portion for delivery to the client over a first transport-layer protocol, e.g., TCP. The second portion is delivered to the client over a second, different transport-layer protocol, e.g., UDP. Accordingly, the method may include the server preparing the first portion of the media data for transmission to the client over the first transport-layer protocol, and preparing the second portion of the media data for transmission to the client over the second transport-layer protocol. The first and second portions of the media data are prepared for transmission in an at least partially time-overlapping or even synchronous manner.

The method according to the second aspect may further include the server receiving an indication of a measured throughput of the first portion of the media data transmitted over the first transport-layer protocol, and/or an indication of a buffer state related to the first portion of the media data received by the client over the first transport-layer protocol. The method may further include the server controlling an amount or rate of the second portion of the media data prepared for transmission to the client over the second transport-layer protocol in response to the indication and based on the measured throughput or buffer state.

In either of the aforementioned aspects, the media data may be formed of data including a plurality of data units, where some of the data units have a higher priority than some other data units having a lower priority. In these instances, the first portion of the media data may include higher-priority data units, and the second portion of the media data may include lower-priority data units.

More particularly, for example, the media data may be formatted in accordance with a scalable video coding (SVC) format or multi-view coding (MVC) format, or encoded as a series of pictures. In the SVC format, for example, the media data may include a higher-priority base layer and one or more lower-priority enhancement layers. In the MVC format, for example, the media data may include a higher-priority base view and lower-priority one or more secondary views. Encoded as a series of pictures, the media data may include higher-priority intra-coded pictures interspersed with lower-priority inter-coded pictures. In an instance in which the media data is formatted in accordance with a scalable video format, first portion of the media data may include the higher-priority base layer. The second portion of the media data may include the one or more lower-priority enhancement layers. In an instance in which the media data is formatted in accordance with a multi-view video coding format, the first portion of the media data may include the higher-priority base view, and the second portion of the media data may include the lower-priority one or more secondary views. In an instance in which the media data is encoded as a series of pictures, the first portion of the media data may include the higher-priority intra-coded pictures, and the second portion of the media data may include the one or more lower-priority inter-coded pictures.

According to other aspects of example embodiments of the present invention, an apparatus may be provided that includes at least one processor, and at least one memory including computer program code. The at least one memory and the computer program code may be configured to, with the at least one processor, cause the apparatus to at least perform the method of the first aforementioned aspect. And in another aspect, the at least one memory and the computer program code may be configured to, with the at least one processor, cause the apparatus to at least perform the method of the second aforementioned aspect.

According to further aspects of example embodiments of the present invention, a computer-readable memory may be provided that has computer-readable program code portions stored therein. The computer-readable program code portions cause an apparatus to at least perform the method of the first aforementioned aspect when executed by at least one processor. In another further aspect, the computer-readable program code portions cause an apparatus to at least perform the method of the second aforementioned aspect when executed by at least one processor.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system according to various example embodiments of the present invention;

FIG. 2 is a schematic block diagram of an apparatus that may be configured to function as a client or server to perform example methods of the present invention;

FIG. 3 illustrates the TCP/IP model and an example implementation of the respective model according to example embodiments of the present invention;

FIGS. 4 and 5 are schematic block diagrams of a system of according to various example embodiments of the present invention;

FIG. 6 is a schematic block diagram of a system of according to a more particular example embodiment of the present invention; and

FIGS. 7 and 8 are flowcharts illustrating various operations in methods of example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. Reference may be made herein to terms specific to a particular system, architecture or the like, but it should be understood that example embodiments of the present invention may be equally applicable to other similar systems, architectures or the like. For instance, example embodiments of the present invention may be equally applied in various types of distributed networks, such as ad-hoc networks, grid computing, pervasive computing, ubiquitous computing, peer-to-peer, cloud computing for Web service or the like.

The terms “data,” “content,” “information,” and similar terms may be used interchangeably, according to some example embodiments of the present invention, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Further, as used herein, the term “circuitry” refers to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory/memories that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

Further, as described herein, various messages or other communication may be transmitted or otherwise sent from one component or apparatus to another component or apparatus, and various messages/communication may be received by one component or apparatus from another component or apparatus. It should be understood that transmitting a message/communication may include not only transmission of the message/communication, and receiving a message/communication may include not only receipt of the message/communication. That is, transmitting a message/communication may also include preparation of the message/communication for transmission, or otherwise causing transmission of the message/communication, by a transmitting apparatus or various means of the transmitting apparatus. Similarly, receiving a message/communication may also include causing receipt of the message/communication, by a receiving apparatus or various means of the receiving apparatus.

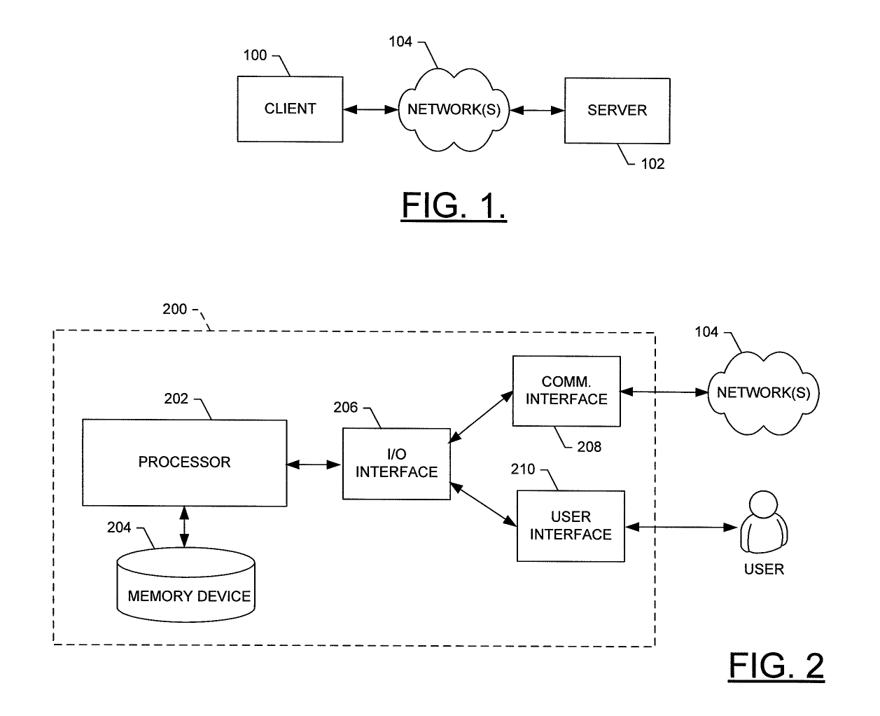

FIG. 1 depicts a system according to various example embodiments of the present invention. The system of example embodiments of the present invention supports media streaming and permits a hybrid transport-layer protocol media streaming. As shown, the system includes apparatuses such as a client 100 and server 102 configured to communicate across one or more networks 104. The network(s) 104 may include one or more wide area networks (WANs) such as the Internet, and may include one or more additional wireline and/or wireless networks configured to interwork with the WAN, such as directly or via one or more core network backbones. Examples of suitable wireline networks include area networks such as personal area networks (PANs), local area networks (LANs), campus area networks (CANS), metropolitan area networks (MANs) or the like. Examples of suitable wireless networks include radio access networks such as 3rd Generation Partnership Project (3GPP) radio access networks, Universal Mobile Telephone System (UMTS) radio access UTRAN (Universal Terrestrial Radio Access Network), Global System for Mobile communications (GSM) radio access networks, Code Division Multiple Access (CDMA) 2000 radio access networks, wireless LANs (WLANs) such as IEEE 802.xx networks, e.g., 802.11a, 802.11b, 802.11g, 802.11n, etc., world interoperability for microwave access (WiMAX) networks, IEEE 802.16, and/or wireless PANs (WPANs) such as IEEE 802.15, Bluetooth, low power versions of Bluetooth, infrared (IrDA), ultra wideband (UWB), Wibree, Zigbee or the like. 3GPP radio access networks may include, for example, 3rd Generation (3G) or 3.9G, also referred to as UTRAN Long Term Evolution (LTE) or Super 3G, or E-UTRAN (Evolved UTRAN) networks. Generally, a radio access network may refer to any 2nd Generation (2G), 3G, 4th Generation (4G) or higher generation mobile communication network and their different versions, radio frequency (RF) or any of a number of different wireless networks, as well as to any other wireless radio access network that may be arranged to interwork with such networks.

The client 100 may be any type of wired or wireless device that is configured to receive and present streaming media data. The client may be a mobile terminal, e.g., a mobile phone, a stationary terminal, e.g., a personal computer, or the like. Via the network(s) and a streaming media connection between the client and server 102, the client may request and receive media data from the server to be presented on a user interface of the client. Although the system may include various types of servers, the server of various example embodiments may be a streaming server, service provider or the like, and the streaming media connection may support streaming over a hybrid combination of multiple different transport layer protocols. Although a server will be described herein as providing the streaming media data or other content, the server is merely one example of a network node that may provide such functionality and, as such, the subsequent discussion of the server and its functionality should be understood to be more generally applicable to a network node that is configured to perform the operations described below in conjunction with the server.

The media data that may be streamed from the server 102 to the client 100 may include, for example, real-time media data or non-real-time media data. Examples of real-time media include speech, audio, video, timed text or the like, and examples of non-real-time media include still images, bitmap graphics, vector graphics, text, scene descriptions or the like. The media may be formatted in any of a number of different manners. In the context of video, suitable formats include, for example, H.264, MPEG-4, MPEG including extensions thereof or the like. In these or similar video formats, video media may be encoded as a series of pictures, which may include higher-priority intra-coded pictures (I-pictures) interspersed with lower-priority inter-coded pictures such as predicted pictures (P-pictures) and/or bi-predictive pictures (B-pictures).

In a more particular example, the media may be formatted in accordance with the scalable video coding (SVC) or multi-view video coding (MVC) format, each of which is an extension to H.264/advanced video coding (AVC). SVC was designed to address earlier shortcomings of scalable video coding solutions such as increased complexity and significant compression efficiency penalty as compared to similar single-layer compression. SVC achieves the former by imposing base layer compatibility with H.264/AVC streams as well as the single-loop decoding, and achieves the latter by controlling the drift caused by motion compensation prediction loops not being identical at the encoder and decoder.

SVC generally includes compression of a video into multiple layers including a higher-priority base layer and one or more lower-priority enhancement layers supporting three different types of scalability: spatial scalability, temporal scalability and quality scalability. Temporal scalability may be realized using reference picture selection flexibility in H.264/AVC, as well as B-pictures in which the prediction dependencies are arranged in a hierarchical structure. Spatial scalability enables encoding a video into a video bit stream that includes one or more subset bit streams each of which may provide video at a different spatial resolution. The spatially scalable video caters to different consumer devices with different display capabilities and processing power. Quality scalability enables the achievement of different operation points each of which may yield a different video quality. For quality scalability, SVC supports coarse-grain quality scalability (CGS), as well as medium-grain quality scalability (MGS). CGS achieves a quality refinement layer by decreasing quantization for residual data, which may limit the number of operation points. For encoding the refinement quality layer, CGS supports the same inter-layer prediction tools used in spatial scalability but without upsampling.

MVC may be used to encode multi-view video. MVC makes use of the inter-view similarities to increase the compression efficiency. As a consequence, video decoding dependencies, and hence priorities, may be developed among the views. In stereoscopic video, a higher-priority base view and lower-priority secondary view may be encoded with a dependency of the secondary view on the base view. Each view may then be rendered such that the view is only visible by a single eye of the viewer. Given the disparity between the views, this may create a three-dimensional (3D) effect for the viewer.

Reference is now made to FIG. 2, which illustrates an apparatus 200 that may be configured to function as the client 100 or server 102 to perform example methods of the present invention. In some example embodiments, the apparatus may, be embodied as, or included as a component of, a communications device with wired or wireless communications capabilities. The example apparatus may include or otherwise be in communication with one or more processors 202, memory devices 204, Input/Output (I/O) interfaces 206, communications interfaces 208 and/or user interfaces 210 with one of each being shown. In various example embodiments, the apparatus may not include one or more of the aforementioned components, and/or may include one or more additional components. The components of the apparatus may depend, for example, on whether the apparatus is configured to function as the client 100 or server 102.

The processor 202 may be embodied as various means for implementing the various functionalities of example embodiments of the present invention including, for example, one or more of a microprocessor, a coprocessor, a controller, a special-purpose integrated circuit such as, for example, an application specific integrated circuit (ASIC), an field programmable gate array (FPGA), digital signal processor (DSP), hardware accelerator, processing circuitry or other similar hardware. According to one example embodiment, the processor may be representative of a plurality of processors, or one or more multi-core processors, operating individually or in concert. A multi-core processor enables multiprocessing within a single physical package. Examples of a multi-core processor include two, four, eight, or greater numbers of processing cores. Further, the processor may be comprised of a plurality of transistors, logic gates, a clock, e.g., oscillator, other circuitry, and the like to facilitate performance of the functionality described herein. The processor may, but need not, include one or more accompanying DSPs. A DSP may, for example, be configured to process real-world signals in real time independent of the processor. Similarly, an accompanying ASIC may, for example, be configured to perform specialized functions not easily performed by a more general purpose processor. In some example embodiments, the processor is configured to execute instructions stored in the memory device or instructions otherwise accessible to the processor. The processor may be configured to operate such that the processor causes the apparatus to perform various functionalities described herein.

Whether configured as hardware alone or via instructions stored on a computer-readable storage medium, or by a combination thereof, the processor 202 may be an apparatus configured to perform operations according to embodiments of the present invention while configured accordingly. Thus, in example embodiments where the processor is embodied as, or is part of, an ASIC, FPGA, or the like, the processor is specifically-configured hardware for conducting the operations described herein. Alternatively, in example embodiments where the processor is embodied as an executor of instructions stored on a computer-readable storage medium, the instructions specifically configure the hardware-based processor to perform the algorithms and operations described herein. In some example embodiments, the processor is a processor of a specific device configured for employing example embodiments of the present invention by further configuration of the processor via executed instructions for performing the algorithms, methods, and operations described herein.

The memory device 204 may be one or more computer-readable storage media. As used herein, a computer-readable media may include transitory computer-readable transmission media and tangible, non-transitory computer-readable storage media. Computer-readable transmission media may include, for example, signals that may propagate between the client 100 and server 102 of the system, and/or components of the apparatus 200. And computer-readable storage media may include, for example, volatile and/or non-volatile memory.

In some example embodiments, the memory device 204 includes Random Access Memory (RAM) including dynamic and/or static RAM, on-chip or off-chip cache memory, and/or the like. Further, the memory device may include non-volatile memory, which may be embedded and/or removable, and may include, for example, Read-Only Memory (ROM), flash memory, magnetic storage devices, e.g., hard disks, floppy disk drives, magnetic tape, etc., optical disc drives and/or media, non-volatile random access memory (NVRAM), and/or the like. The memory device may include a cache area for temporary storage of data. In this regard, at least a portion or the entire memory device may be included within the processor 202.

Further, the memory device 204 may be configured to store information, data, applications, computer-readable program code instructions, and/or the like for enabling the processor 202 and the example apparatus 200 to carry out various functions in accordance with example embodiments of the present invention described herein. For example, the memory device may be configured to buffer input data for processing by the processor. Additionally, or alternatively, the memory device may be configured to store instructions for execution by the processor. The memory may be securely protected, with the integrity of the data stored therein being ensured. In this regard, data access may be checked with authentication and authorized based on access control policies.

The I/O interface 206 may be any device, circuitry, or means embodied in hardware, software or a combination of hardware and software that is configured to interface the processor 202 with other circuitry or devices, such as the communications interface 208 and/or the user interface 210. In some example embodiments, the processor may interface with the memory device via the I/O interface. The I/O interface may be configured to convert signals and data into a form that may be interpreted by the processor. The I/O interface may also perform buffering of inputs and outputs to support the operation of the processor. According to some example embodiments, the processor and the I/O interface may be combined onto a single chip or integrated circuit configured to perform, or cause the apparatus 200 to perform, various functionalities of an example embodiment of the present invention.

The communication interface 208 may be any device or means embodied in hardware, software or a combination of hardware and software that is configured to receive and/or transmit data from/to one or more networks 104 and/or any other device or module in communication with the example apparatus 200. The processor 202 may also be configured to facilitate communications via the communications interface by, for example, controlling hardware included within the communications interface. In this regard, the communication interface may include, for example, one or more antennas, a transmitter, a receiver, a transceiver and/or supporting hardware, including, for example, a processor for enabling communications. Via the communication interface, the example apparatus may communicate with various other network elements in a device-to-device fashion and/or via indirect communications.

The communications interface 208 may be configured to provide for communications in accordance with any of a number of wired or wireless communication standards. The communications interface may be configured to support communications in multiple antenna environments, such as multiple input multiple output (MIMO) environments. Further, the communications interface may be configured to support orthogonal frequency division multiplexed (OFDM) signaling. In some example embodiments, the communications interface may be configured to communicate in accordance with various techniques including, as explained above, any of a number of 2G, 3G, 4G or higher generation mobile communication technologies, RF, IrDA or any of a number of different wireless networking techniques. The communications interface may also be configured to support communications at the network layer, such as via Internet Protocol (IP).

The user interface 210 may be in communication with the processor 202 to receive user input via the user interface and/or to present output to a user as, for example, audible, visual, mechanical or other output indications. The user interface may include, for example, a keyboard, a mouse, a joystick, a display, e.g., a touch screen display, a microphone, a speaker, or other input/output mechanisms. Further, the processor may comprise, or be in communication with, user interface circuitry configured to control at least some functions of one or more elements of the user interface. The processor and/or user interface circuitry may be configured to control one or more functions of one or more elements of the user interface through computer program instructions, e.g., software and/or firmware, stored on a memory accessible to the processor, e.g., the memory device 204. In some example embodiments, the user interface circuitry is configured to facilitate user control of at least some functions of the apparatus 200 through the use of a display and configured to respond to user inputs. The processor may also comprise, or be in communication with, display circuitry configured to display at least a portion of a user interface, the display and the display circuitry configured to facilitate user control of at least some functions of the apparatus.

In some cases, the apparatus 200 of example embodiments may be implemented on a chip or chip set. In an example embodiment, the chip or chip set may be programmed to perform one or more operations of one or more methods as described herein and may include, for instance, one or more processors 202, memory devices 204, I/O interfaces 206 and/or other circuitry components incorporated in one or more physical packages, e.g., chips. By way of example, a physical package includes an arrangement of one or more materials, components, and/or wires on a structural assembly, e.g., a baseboard, to provide one or more characteristics such as physical strength, conservation of size, and/or limitation of electrical interaction. It is contemplated that in certain embodiments the chip or chip set can be implemented in a single chip. It is further contemplated that in certain embodiments the chip or chip set can be implemented as a single “system on a chip.” It is further contemplated that in certain embodiments a separate ASIC may not be used, for example, and that all relevant operations as disclosed herein may be performed by a processor or processors. A chip or chip set, or a portion thereof, may constitute a means for performing one or more operations of one or more methods as described herein.

In one example embodiment, the chip or chip set includes a communication mechanism, such as a bus, for passing information among the components of the chip or chip set. In accordance with one example embodiment, the processor 202 has connectivity to the bus to execute instructions and process information stored in, for example, the memory device 204. In instances in which the apparatus 200 includes multiple processors, the processors may be configured to operate in tandem via the bus to enable independent execution of instructions, pipelining, and multithreading. In one example embodiment, the chip or chip set includes merely one or more processors and software and/or firmware supporting and/or relating to and/or for the one or more processors.

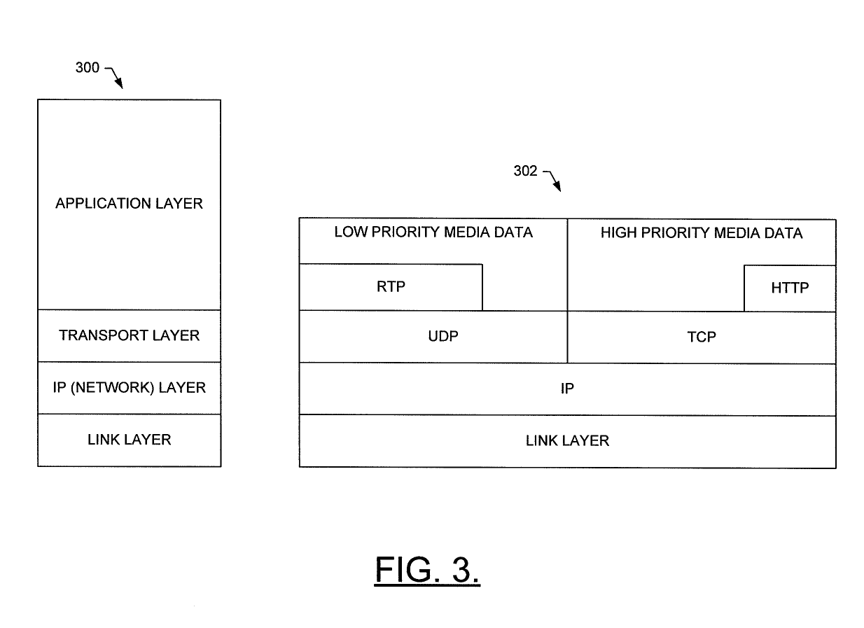

The client 100 and server 102 of example embodiments may operate in accordance with a multilayer protocol stack, such as that provided by or similar to the generic Open Systems Interconnection (OSI) model, TCP/IP model or the like. FIG. 3 illustrates the TCP/IP model 300 and an example implementation 302 of the respective model according to example embodiments of the present invention. FIG. 3 provides the stacks in a manner illustrating a comparison of where layers of the implementation may fit within the TCP/IP model and vice versa. Each layer of the protocol stacks, which may be implemented in hardware alone or in combination with software or firmware, generally performs a specific data communications task, a service to and for the layer that precedes it. The process can be viewed as placing a letter in a series of envelopes before it is sent through the postal system. Each succeeding envelope adds another layer of processing or overhead information necessary to process the transaction. Together, all the envelopes help make sure the letter gets to the right address and that the message received is identical to the message sent. Once the entire package is received at its destination, the envelopes are opened one by one until the letter itself emerges exactly as written.

Actual data flow between the client 100 and server 102 is from top to bottom in the source apparatus, across a connection between the client and server, and then from bottom to top in the destination apparatus. Each time that user application data passes downward from one layer to the next layer in the same apparatus more processing information is added. When that information is removed and processed by the peer layer in the other apparatus, it causes various tasks, such as error correction, flow control, etc., to be performed.

At the top, the TCP/IP model 300 includes an application layer that generally provides an interface for a user application to access the services of the other layers and defines protocols that user applications may use to exchange data. The TCP/IP model also includes a transport layer that generally provides data connection services to applications and may contain mechanisms that guarantee that data is delivered error-free, without omissions and in sequence. The transport layer in the TCP/IP model sends segments by passing them to an IP or network layer, which routes them to the destination. The transport layer accepts incoming segments from the IP layer, determines which application is the recipient, and passes the data to that application in the order in which it was sent. Examples of transport layer protocols include the Transmission Control Protocol (TCP), User Datagram Protocol (UDP), Datagram Congestion Control Protocol (DCCP), Stream Control Transmission Protocol (SCTP), Resource Reservation Protocol (RSVP), Explicit Congestion Notification (ECN) or the like.

The IP layer performs network layer functions and routes data between apparatuses, e.g., client 100 and server 102, via a link or network interface layer. Data may traverse a single link or may be relayed across several links in an IP network. Data is carried in units called datagrams, which include an IP header that contains network layer addressing information. Routers examine the destination address in the IP header in order to direct datagrams to their destinations. The IP layer is called connectionless because every datagram is routed independently and the IP layer does not guarantee reliable or in-sequence delivery of datagrams. The IP layer routes its traffic without caring which application-to-application interaction to which a particular datagram belongs.

The example implementation 302 of the TCP/IP stack may implement a number of protocols and codecs at the application layer. As shown, for example, the example implementation may utilize Real Time Streaming Protocol (RTSP) for session control, Session Description Protocol (SDP) for session description, Real-time Transport Protocol (RTP) for synchronized media data transport, e.g., real-time media, Dynamic and Interactive Multimedia Scenes (DIMS), and Hypertext Transport Protocol (HTTP) for the transport of static media, progressive downloading and adaptive streaming of timed media data. These protocols, then, may be supported by a transport layer implementing UDP and TCP, an IP layer and link layer.

As transport layer protocols, TCP provides a connection-oriented communication service. Prior to exchange of data, a connection is established between the client 100 and the server 102 via a so-called three-way handshake. Following the handshake, a bi-directional data exchange may be performed between the client and server. For a connection to be established, the server may bind to a local port to register as a receiver for connections. Using an IP address of the server and a number of the bound port, the client may initiate the connection to the server.

TCP offers a reliable protocol where data is delivered error free, in-order and without duplicates. The error-free delivery may be guaranteed by using acknowledgement and retransmission of lost packets. In-order delivery may be ensured through re-arranging out-of-order packets based on their sequence numbers. And duplicates may be discovered and discarded using sequence numbers of TCP.

Further, TCP offers flow and congestion control. Flow control may ensure that the source, e.g., server 102, does not overwhelm the destination, e.g., client 100, with too many packets. A sliding window may be used for this purpose, where the number of packets that can be transmitted without yet receiving an acknowledgement may be limited by the size of the window. The congestion control in TCP may ensure that the data transmission reacts and adapts to the available end-to-end bandwidth. The transmission rate of the source may be reduced multiplicatively upon detection of signs of congestion such as packet loss or excessive delays.

UDP provides an alternative to TCP as a transport layer protocol. Contrary to TCP, UDP represents a minimal transport protocol that is relatively simple to implement and use. UDP defines source and destination ports to enable application addressability, and also defines a checksum that offers the destination the possibility to verify correct reception of datagrams. UDP does not require connection establishment prior to data transmission, and consequently, no state information may be kept between source and destination. UDP also may not provide reliable transport as UDP generally lacks sequence numbering, in-order delivery, packet retransmission, flow and congestion control.

RTP over UDP may be used for streaming media data. UDP provides basic transport functionality such as application addressing and corruption detection. RTP complements UDP with media transport relevant functionality, such as loss detection, packet re-ordering, synchronization, statistical data collection, and session participant identification. RTP/UDP does not provide built-in congestion control or error correction functionality, but instead gathers sufficient information for the application to implement those mechanisms on a need basis. With the rising popularity of mobile and Internet video, good network behavior through appropriate rate control mechanisms becomes even more important. Another challenge that RTP/UDP-based streaming applications have to circumvent is that of network address translator (NAT) and firewall traversal.

Given the issues of the RTP/UDP-based solution and the fact that bandwidth availability may not be perceived as a major concern, media streaming using HTTP may be adopted and deployed. HTTP typically uses TCP as the underlying transport protocol. HTTP is a textual protocol, where a message includes an HTTP header and message body separated by an empty line. The message header includes a request line followed by a set of lines, named header fields. The request line indicates the HTTP version number, the request method and/or the response code. HTTP defines a set of commands for fetching, uploading, and updating content on the server. Entities on a server are addressed using Uniform Resource Locators (URL).

HTTP also defines a set of functionalities for optimizing the delivery and caching. Entities may be cached by intermediate network caches and by the receiver itself. The entities may be assigned a validity time, during which the stored copy of an entity may be considered as fresh. In that case, the entity is served from the cache upon request. Otherwise, a fresh copy of the entity will be retrieved from the original server.

In contrast to the RTP/UDP-based solution, HTTP-based transport may facilitate seamless and transparent streaming with minimal configuration effort and high reliability. However, HTTP streaming comes at the cost of inefficient usage of the available bandwidth caused by the nature of the TCP protocol as well as a higher start-up time.

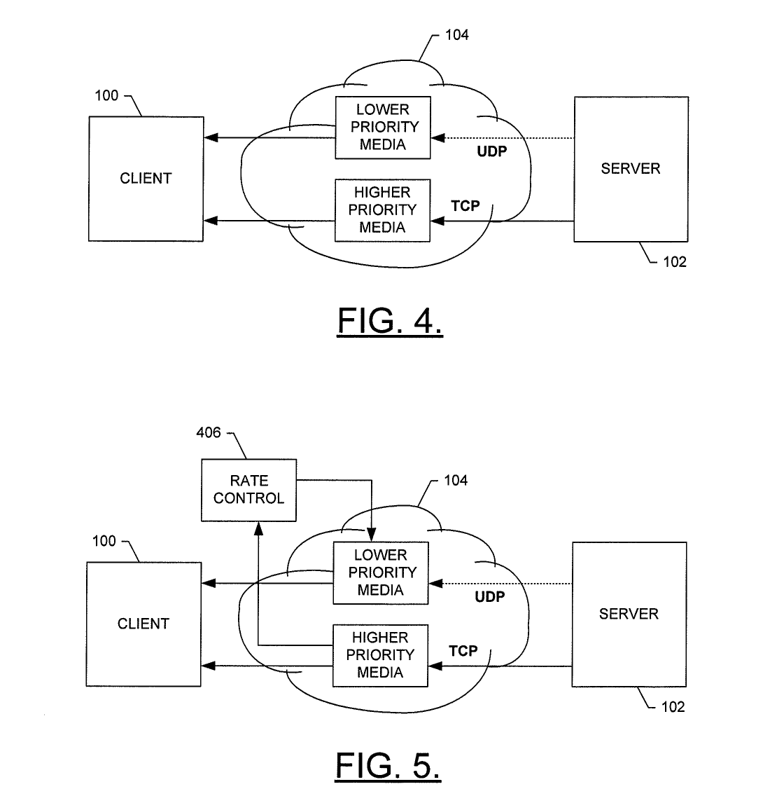

Example embodiments of the present invention therefore provide a mechanism for hybrid streaming over multiple transport-layer protocols in an at least partially overlapping or even simultaneous manner. According to example embodiments, the client 100 establishes a streaming session with a server 102 to receive a stream of media data from the server. The media data may include a plurality of data units, e.g., packets, which the server may partition into at least a first portion and a second, different portion. The server may then provide the client with a description of the session, e.g., SDP, indicating delivery of the first portion of data over a first transport-layer protocol and the second portion of data over a second, different transport-layer protocol, and accordingly deliver the portions of data over the transport-layer protocols. This is shown, for example, in FIG. 4. Example embodiments are described herein in the context of TCP and UDP as the transport-layer protocols over which portions of the media data are delivered, such as in accordance with RTP, HTTP or the like at the application layer. It should be understood, however, that other transport-layer protocols may be used in addition to or in lieu of TCP and UDP. It should further be understood that the media may be partitioned into more than two partitions.

The media data may be partitioned in any of a number of different manners. For example, the media data may be partitioned based on any one or more properties of the data that may distinguish some data units from some other data units. These properties may include a relative priority or importance of media data units. The server 102 of one example embodiment may deliver a first portion of data including more important or higher priority data units over TCP to facilitate timely and reliable delivery of that data, albeit possibly at a lower bitrate as compared to delivery over UDP. The server may further deliver a second portion of data including less important or lower priority data units over UDP. For this second portion, the server may control reliability and transmission rate to use a substantial portion of the available channel bitrate, and to not interfere with delivery of the first portion over TCP.

In the case of scalable video such as SVC video, for example, data units that belong to the higher-priority base layer may be partitioned into a first portion of media data and transported over TCP, and the remaining data units, belonging to the lower-priority enhancement layer(s), may be partitioned into a second portion and transported over UDP. In the case of non-scalable video such as MPEG-4, MPEG or the like, for example, data units that belong to higher-priority intra-coded pictures may be partitioned into a first portion of media data and transported over TCP, and the remaining data units, belonging to the lower-priority inter-coded pictures, may be partitioned into a second portion and transported over UDP. And in the case of MVC, for example, data units that belong to the higher-priority base view may be partitioned into a first portion of media data and transported over TCP, and the remaining data units, belonging to the lower-priority secondary view, may be partitioned into a second portion and transported over UDP.

As indicated above, the server 102 may provide the client 100 with a description of a streaming session over multiple transport-layer protocols according to example embodiments of the present invention. The description may be provided, for example, in accordance with SDP, and delivered over RTP, HTTP or the like. The description may be provided in a single file or message across the portions over multiple transport-layer protocols, or may be provided in multiple files or messages such as in the case of a file or message for each portion over a respective transport-layer protocol. The following is an example of a SDP file that describes a media streaming session that makes use of simultaneous transport over TCP and UDP.

v=0
o=− 4 4 IN IP4 127.0.0.1
s=Example
i=Example
e=username@domain.com
c=IN IP4 0:0:0:0
b=AS:900
t=0 9320
a=range:npt=0- 360000.000
m=video 27102 TCP 102
b=AS:300
a=tcpmap:102 H264/90000
a=control:trackID=1
a=fmtp:102 profile-level-id=42E00C; packetization-mode=0;
sprop-parameter-sets=Z0LADLkQKDVUA=,aM4yyA==;
a=setup: active
a=connection:new
m=audio 27110 TCP 110
b=AS:64
a=tcpmap:110 MP4-LATM/22050/2
a=control:trackID=4
a=setup: active
a=connection:new
m=video 27104 RTP/AVP 104
b=AS:500
a=rtpmap:104 SVC/90000
a=control:trackID=2
a=fmpt:104 profile-level-id=66F00D;
a=depend:104 svc M1:102

In the previous example, the client 100 requested to establish a streaming session over a TCP connection with the server 102 to receive a stream of media data including two SVC video layers and one audio layer. The server responds to the request by establishing a session in which the audio and the base layer of the video are delivered over TCP; and the video enhancement layer, which is dependent on the base layer of the video, is delivered using RTP over UDP. The setup attribute indicates a request to the client to initiate the TCP connection to the server, and the connection attribute indicates that a new connection needs to be established for this media stream. For further information regarding the lines or fields of such a SDP file, see Internet Engineering Task Force (IETF) Request for Comments (RFC) 2327 and RFC 4145.

In another embodiment, the description may be delivered as a part of an HTTP Streaming description file or manifest file, which is given in XML format. The description may indicate that certain portions of the media data are not delivered via HTTP/TCP but rather via UDP, for example using RTP/UDP or another similar protocol.

As shown schematically in FIG. 5, example embodiments of the present invention may further employ a congestion-control algorithm 406 to control the delivery of the media data over UDP. Congestion control according to example embodiments of the present invention may avoid throttling the TCP connection in favor of UDP traffic, and may facilitate meeting the bandwidth needs of the higher priority media data delivered over TCP. The congestion-control algorithm may be implemented in hardware, software or a combination of hardware and software, and may include, for example, monitoring the TCP throughput or buffer state of the portion of media data delivered over TCP. Information indicating the throughput/buffer state may then be used to control the amount or rate of data delivered over UDP.

The congestion control algorithm 406 may be implemented in a number of different manners by the client 100, server 102 or both. In one example embodiment, the client may monitor the throughput of the TCP connection, and notify the server to reduce the amount of data that is flowing over UDP in instances in which the TCP throughput drops below a certain level. In the case of SVC-formatted media, reducing the amount of data over UDP may be accomplished, for example, by dropping some of the enhancement layers delivered to the client.

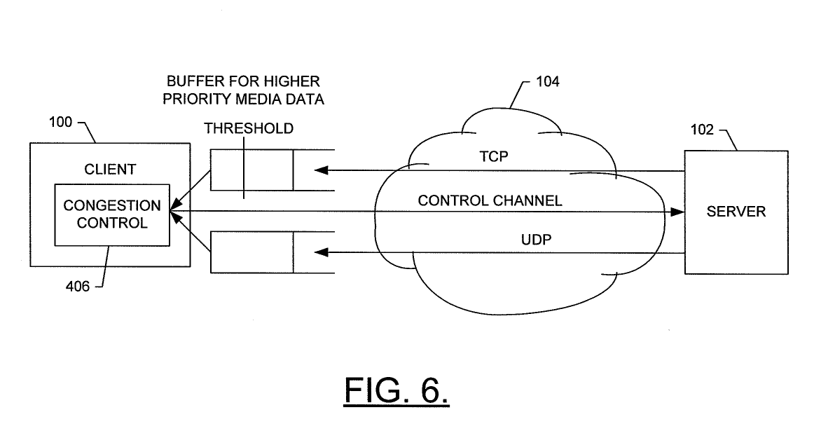

In another example embodiment illustrated in FIG. 6, the client 100, such as the processor 202, may continuously measure an amount of media data received over TCP and buffered for use at the client. In instances in which the amount of buffered data drops below a certain threshold, the client may send the server 102 a notification over a control channel to thereby notify the server to reduce the amount of media data delivered over UDP. In a more particular example extending the above example of streaming media data including two SVC video layers and one audio layer, the client may observe the level of the buffer for the higher-priority base layer and the audio data. In instances in which the buffered media time is below a certain threshold, the client may notify the server to drop the enhancement layer delivered over UDP.

In another example embodiment, the server 102 may assume the congestion control algorithm. In such instances, the server, such as the processor 202, may measure the throughput of the TCP connection to discover changes in the available bandwidth. Additionally or alternatively, the server may receive feedback information from the client 100 that indicates the level of media data the client is buffering from the TCP connection, e.g., higher-priority media data. In instances in which the server discovers that the available bandwidth drops, the server, such as the processor 202, may respond by reducing the amount of data delivered over UDP.

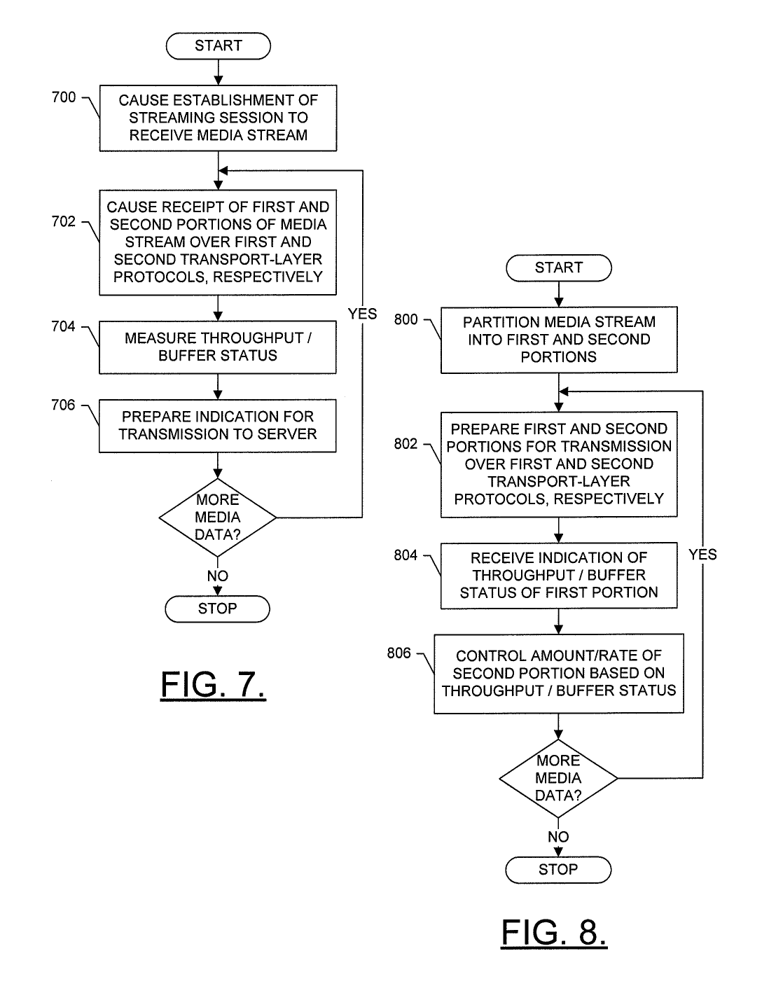

Reference is made to FIGS. 7 and 8, which present flowcharts illustrating various operations that may be performed by a client 100 and server 102, respectively, according to example embodiments of the present invention. In FIG. 7, the client may include means, such as one or more of processor(s) 202, communication interface(s) 208, e.g., transmitter, antenna, etc., or the like, for causing establishment of a streaming session of the client with a server to receive a stream of media data from the server, including receiving a description of the session, as shown in block 700. The description indicates delivery of a first portion of the media data to the client over a first transport-layer protocol, and delivery of a second, different portion of the media data to the client over a second, different transport-layer protocol, the server partitioning the media data into the first and second portions. The client may also include means, such as processor(s), communication interface(s) or the like, for causing receipt of the first portion of the media data transmitted to the client over the first transport-layer protocol, and receipt of the second portion of the media data transmitted to the client over the second transport-layer protocol, as shown in block 702. In this regard, the client receives the first and second portions of the media data in an at least partially overlapping or even synchronous manner.

The client 100 may also include means, such as processor(s) 202, for measuring a throughput or otherwise receiving an indication of a measured throughput of the first portion of the media data transmitted to the client over the first transport-layer protocol, as shown in block 704. Additionally or alternatively, the respective means may be for receiving an indication of a buffer state related to the first portion of the media data received by the client over the first transport-layer protocol, as also shown in block 704. And the client may include means, such as processor(s), for preparing the indication for transmission to the server in response to the indication, as shown in block 706. This indication enables the server to control an amount or rate of the second portion of the media data transmitted to the client over the second transport-layer protocol based on the measured throughput or buffer state.

In FIG. 8, the server 102 may include means, such as processor(s) 202 for partitioning a stream of media data into a first portion and a second, different portion for delivery to a client during a streaming session, as shown in block 800. In this regard, the media data is partitioned into the first portion for delivery to the client over a first transport-layer protocol, and into the second portion for delivery to the client over a second, different transport-layer protocol. Accordingly, the server may include means, such as processor(s), communication interface(s) or the like, for preparing the first portion of the media data for transmission to the client over the first transport-layer protocol, and preparing the second portion of the media data for transmission to the client over the second transport-layer protocol, as shown in block 802. The first and second portions of the media data are prepared for transmission in an at least partially overlapping or even synchronous manner.

The server 102 may also include means, such as processor(s) 202, for receiving an indication of a measured throughput of the first portion of the media data transmitted over the first transport-layer protocol, or a buffer state related to the first portion of the media data received by the client over the first transport-layer protocol, as shown in block 804. And the server may include means, such as processor(s), communication interface(s) or the like, for controlling an amount or rate of the second portion of the media data prepared for transmission to the client over the second transport-layer protocol in response to the indication and based on the throughput or buffer state, as shown in block 806.

According to one aspect of the example embodiments of present invention, functions performed by the client 100 and/or server 102, such as those illustrated by the flowcharts of FIGS. 7 and 8, may be performed by various means. It will be understood that each block or operation of the flowcharts, and/or combinations of blocks or operations in the flowcharts, can be implemented by various means. Means for implementing the blocks or operations of the flowcharts, combinations of the blocks or operations in the flowcharts, or other functionality of example embodiments of the present invention described herein may include hardware, alone or under direction of one or more computer program code instructions, program instructions or executable computer-readable program code instructions from a computer-readable storage medium. In this regard, program code instructions may be stored on a memory device, such as the memory device 204 of the example apparatus, and executed by a processor, such as the processor 202 of the example apparatus. As will be appreciated, any such program code instructions may be loaded onto a computer or other programmable apparatus, e.g., processor, memory device, or the like, from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowcharts by a processor, or storage of instructions associated with the blocks or operations of the flowcharts in a computer-readable storage medium, supports combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. An apparatus comprising:
at least one processor; and
at least one memory including computer program code,
the at least one memory and the computer program code configured to, with the at least one processor, cause the apparatus to at least:
partition a stream of media data into a first portion and a second portion for delivery to a client during a streaming session, the first portion being delivered to the client over a first transport-layer protocol, and the second portion being delivered to the client over a second transport-layer protocol;
transmit the first portion of the media data to the client over the first transport-layer protocol; and
transmit the second portion of the media data to the client over the second transport-layer protocol,
wherein the first and second portions of the media data are prepared for transmission in an at least partially time-overlapping manner.

2. The apparatus of claim 1, wherein the first transport-layer protocol comprises a Transmission Control Protocol, and the second transport-layer protocol comprises a User Datagram Protocol.

3. The apparatus of claim 1, wherein the media data is formed of data including a plurality of data units, some of the data units having a higher priority than some other data units having a lower priority, and
wherein the first portion of the media data comprises higher-priority data units, and the second portion of the media data comprises lower-priority data units.

4. The apparatus of claim 3, wherein the media data comprises at least one of:
media data formatted in accordance with a scalable video format, wherein the first portion of the media data comprises a higher-priority base layer, and the second portion of the media data comprises one or more lower-priority enhancement layers,
media data formatted in accordance with a multi-view video coding format, wherein the first portion of the media data comprises a higher-priority base view, and the second portion of the media data comprises a lower-priority secondary view, or
media data encoded as a series of pictures, wherein the first portion of the media data comprises higher-priority intra-coded pictures, and the second portion of the media data comprises one or more lower-priority inter-coded pictures.

5. The apparatus of claim 1, wherein the at least one memory and the computer program code are further configured to, with the at least one processor, cause the apparatus to further:
receive an indication of a throughput of the first portion of the media data transmitted over the first transport-layer protocol, or an indication of a buffer state of the first portion of the media data received by the client over the first transport-layer protocol; and
control an amount or rate of the second portion of the media data prepared for transmission to the client over the second transport-layer protocol based on the throughput or buffer state.

6. An apparatus comprising:
at least one processor; and
at least one memory including computer program code,
the at least one memory and the computer program code configured to, with the at least one processor, cause the apparatus to at least:
establish a streaming session with a server to receive a stream of media data from the server, including receive a description of the session from the server indicating delivery of a first portion of the media data to the apparatus over a first transport-layer protocol, and delivery of a second portion of the media data to the apparatus over a second transport-layer protocol to the apparatus; and
receive the first portion of the media data transmitted to the apparatus over the first transport-layer protocol, and receive the second portion of the media data transmitted to the apparatus over the second transport-layer protocol, wherein the first and second portions of the media data are received in an at least partially time-overlapping manner.

7. The apparatus of claim 6, wherein the first transport-layer protocol comprises a Transmission Control Protocol, and the second transport-layer protocol comprises a User Datagram Protocol.

8. The apparatus of claim 6, wherein the media data is formed of data including a plurality of data units, some of the data units having a higher priority than some other data units having a lower priority, and
wherein the first portion of the media data comprises higher-priority data units, and the second portion of the media data comprises lower-priority data units.

9. The apparatus of claim 8, wherein the media data comprises at least one of:
media data formatted in accordance with a scalable video format, wherein the first portion of the media data comprises a higher-priority base layer, and the second portion of the media data comprises one or more lower-priority enhancement layers,
media data formatted in accordance with a multi-view video coding format, wherein the first portion of the media data comprises a higher-priority base view, and the second portion of the media data comprises a lower-priority secondary view, or
media data encoded as a series of pictures, wherein the first portion of the media data comprises higher-priority intra-coded pictures, and the second portion of the media data comprises one or more lower-priority inter-coded pictures.

10. The apparatus of claim 6, wherein the at least one memory and the computer program code are further configured to, with the at least one processor, cause the apparatus to further:
receive an indication of a throughput of the first portion of the media data transmitted to the client over the first transport-layer protocol, or an indication of a buffer state of the first portion of the media data received by the client over the first transport-layer protocol; and
prepare the indication for transmission to the server to enable the server to control an amount or rate of the second portion of the media data transmitted to the client over the second transport-layer protocol based on the throughput or buffer state.

11. A method comprising:
partitioning a stream of media data into a first portion and a second portion for delivery to a client during a streaming session, the first portion being delivered to the client over a first transport-layer protocol, and the second portion being delivered to the client over a second transport-layer protocol;
transmit the first portion of the media data to the client over the first transport-layer protocol; and
transmit the second portion of the media data to the client over the second transport-layer protocol,
wherein the first and second portions of the media data are prepared for transmission in an at least partially time-overlapping manner, and
wherein partitioning a media data and preparing the first and second portions for transmission are performed by an apparatus comprising a processor configured to cause the apparatus to partition a media data and prepare the first and second portions for transmission.

12. The method of claim 11, wherein the first transport-layer protocol comprises a Transmission Control Protocol, and the second transport-layer protocol comprises a User Datagram Protocol.

13. The method of claim 11, wherein the media data is formed of data including a plurality of data units, some of the data units having a higher priority than some other data units having a lower priority, and
wherein the first portion of the media data comprises higher-priority data units, and the second portion of the media data comprises lower-priority data units.

14. The method of claim 11, wherein the media data comprises at least one of:
media data formatted in accordance with a scalable video format, wherein the first portion of the media data comprises a higher-priority base layer, and the second portion of the media data comprises one or more lower-priority enhancement layers,
media data formatted in accordance with a multi-view video coding format, wherein the first portion of the media data comprises a higher-priority base view, and the second portion of the media data comprises a lower-priority secondary view, or
media data encoded as a series of pictures, wherein the first portion of the media data comprises higher-priority intra-coded pictures, and the second portion of the media data comprises one or more lower-priority inter-coded pictures.

15. The method of claim 11 further comprising:
receiving an indication of a throughput of the first portion of the media data transmitted over the first transport-layer protocol, or an indication of a buffer state of the first portion of the media data received by the client over the first transport-layer protocol; and
controlling an amount or rate of the second portion of the media data prepared for transmission to the client over the second transport-layer protocol based on the throughput or buffer state.

16. A method comprising:
establishing a streaming session of a client with a server to receive a stream of media data from the server, including receiving a description of the session from the server indicating delivery of a first portion of the media data to the client over a first transport-layer protocol, and delivery of a second portion of the media data to the client over a second transport-layer protocol; and
receiving the first portion of the media data transmitted to the client over the first transport-layer protocol, and receiving the second portion of the media data transmitted to the client over the second transport-layer protocol, wherein the first and second portions of the media data are received in an at least partially time-overlapping manner,
wherein establishing a streaming session and receiving the first and second portions of the media data are performed by an apparatus comprising a processor configured to cause the apparatus to establish a streaming session and receive the first and second portions of the media data.

17. The method of claim 16, wherein the first transport-layer protocol comprises a Transmission Control Protocol, and the second transport-layer protocol comprises a User Datagram Protocol.

18. The method of claim 16, wherein the media data is formed of data including a plurality of data units, some of the data units having a higher priority than some other data units having a lower priority, and
wherein the first portion of the media data comprises higher-priority data units, and the second portion of the media data comprises lower-priority data units.

19. The method of claim 16, wherein the media data comprises at least one of:
media data formatted in accordance with a scalable video format, wherein the first portion of the media data comprises a higher-priority base layer, and the second portion of the media data comprises one or more lower-priority enhancement layers,
media data formatted in accordance with a multi-view video coding format, wherein the first portion of the media data comprises a higher-priority base view, and the second portion of the media data comprises a lower-priority secondary view, or
media data encoded as a series of pictures, wherein the first portion of the media data comprises higher-priority intra-coded pictures, and the second portion of the media data comprises one or more lower-priority inter-coded pictures.

20. The method of claim 16 further comprising:
receiving an indication of a throughput of the first portion of the media data transmitted to the client over the first transport-layer protocol, or an indication of a buffer state of the first portion of the media data received by the client over the first transport-layer protocol; and
preparing the indication for transmission to the server to enable the server to control an amount or rate of the second portion of the media data transmitted to the client over the second transport-layer protocol based on the throughput or buffer state.

21. A computer-readable memory including computer executable instructions, the computer executable instructions when executed cause an apparatus to perform at least the following:
partitioning a media data into a first portion and a second portion for delivery to a client during a streaming session, wherein the first portion being delivered to the client over a first transport-layer protocol, and the second portion being delivered to the client over a second transport-layer protocol;
transmitting the first portion of the media data to the client over the first transport-layer protocol; and
transmitting the second portion of the media data to the client over the second transport-layer protocol,
wherein the first and second portions of the media data are prepared for transmission in an at least partially time overlapping manner.

22. A computer-readable memory including computer executable instructions, the computer executable instructions when executed cause an apparatus to perform at least the following:
establishing a streaming session with a server to receive a media stream from the server, including receive a description of the session from the server indicating delivery of a first portion of the media data to the apparatus over a first transport-layer protocol, and delivery of a second portion of the media stream to the apparatus over a second transport-layer protocol to the apparatus; and
receiving the first portion of the media data transmitted to the apparatus over the first transport-layer protocol, and receive the second portion of the media data transmitted to the apparatus over the second transport-layer protocol, wherein the first and second portions of the media data are received in an at least partially time-overlapping manner.
